(19) United States
(12) Patent Application Publication
(10) Pub. No.: US 2012/0193545 A1
(43) Pub. Date: Aug. 2, 2012

(54) DETECTOR SYSTEMS WITH ANODE INCIDENCE FACE AND METHODS OF FABRICATING THE SAME

(75) Inventors: John Eric Tkaczyk, Delanson, NY (US); James Wilson Rose, Guilderland, NY (US); Vladimir A. Lobastov, Clifton Park, NY (US); Jeffrey Seymour Gordon, Lexington, MA (US)

(73) Assignee: GENERAL ELECTRIC COMPANY, SCHENECTADY, NY (US)

(21) Appl. No.: 13/017,765

(22) Filed: Jan. 31, 2011

(51) Int. Cl. G01T 1/24; B23P 11/00

(52) U.S. Cl. 250/370.08; 29/428

(57) ABSTRACT

A detector module for an imaging system, such as a CT system, and a method for fabricating the same are presented. The detector module includes an array of direct conversion sensors, the direct conversion sensors having a first side and a second side. The first side of the direct conversion sensors includes a segmented electrode side forming an array of pixels that receive radiation and convert the received radiation into corresponding charge signals, whereas the second side includes a common electrode side. The detector module also includes a readout electronic circuitry coupled to one or more of the direct conversion sensors where the readout electronic circuitry is configured to be shielded from the radiation. In addition, the detector module includes a bias voltage circuitry coupled to the one or more direct conversion sensors on the second side.

### BACKGROUND

Embodiments of the present technique relate generally to imaging systems, and more particularly to detector systems for radiographic imaging systems.

Radiographic imaging systems typically include a radiation source that emits radiation towards an object, such as a patient or a piece of luggage. A radiation beam, after being attenuated by the object, impinges upon an array of radiation detectors. Generally, the radiation beam intensity received at the detector array depends upon the attenuation of the radiation beam through the scanned object. Particularly, each detector in the detector array generates a separate signal indicative of the attenuated beam received by the detector.

To that end, the detector array in the imaging systems employ a plurality of detector modules including, for example, scintillator-photodiode sensor combinations and direct conversion sensors. These detector modules convert X-ray photon energy into current signals that are integrated over a particular time period, then measured, and ultimately digitized. In one implementation, the detector modules include photon-counting (PC) sensors that first convert X-ray photon energy into current pulse signals and then detect these individual pulses. For the photon counting option, detection of the amplitude of the current pulses also provides dose efficient X-ray spectral information, energy discrimination and/or material decomposition capabilities.

As integrated circuit device densities increase while device sizes shrink, detector performance is increasingly impacted by limitations in the available interconnect technology and sensor materials used in fabrication. Conventional photosensors that are used in combination with scintillators typically position a surface of the detector pixels on a side opposite to the radiation incidence side. Such a positioning facilitates the electrical routing of signals from the photodiode to the integration readout electronics. Similarly, direct conversion sensors typically have a common electrode side and a pixel electrode side. Electrons are the majority carrier of electric charge in semiconductors of interest for X-ray direct conversion. As the electron transport dominates in the direct conversion sensors, the pixel electrode is typically biased with a positive voltage relative to the common electrode side. Accordingly, the direct conversion sensor has a segmented anode electrode with a positive bias voltage relative to the common cathode electrode. The segmented anode electrode collects electrons that are routed through the detector packaging to the corresponding readout electronics. Particularly, in conventional sensors, the common cathode typically serves as radiation incidence side, whereas the segmented anode, which may be subdivided into a plurality of pixel elements, is positioned opposite to the radiation incidence side. As previously noted, such a conventional configuration facilitates the electrical routing of signals from the anode pixels to the readout electronics.

Conventional sensor configurations using the common cathode illumination, however, entail the electrons generated by X-ray absorption in the sensor material near the cathode to travel across the thickness of the sensor material before reaching the anode. The limitations in the quality of the available sensor material cause trapping of charges at defects in the sensor material. Further, the nature of the trapped charges changes the internal electric field in such conventional detector configurations. In particular, the electric field decreases for the majority carrier because of the long travel distance across the sensor material from the cathode to anode where connections are made to the read-out electronic circuitry. Particularly, a portion of the charge is trapped in the sensor material during transport resulting in a decrease in the charge collection efficiency of the detector system. Further, continual changes in the trapped charges diminish the stability and reproducibility of the detector response. Conventional detector configurations, thus, fail to provide higher flux rates and intensity for various imaging operations, such as those requiring high statistical significance.

It is desirable to develop detector systems that overcome flux rate limitations in conventional detectors and provide stable detector operations. Additionally, there is a need for detector systems with sensors that provide higher charge collection efficiency, and thus are suitable for operating at higher flux rates and higher intensity X-rays for use in a variety of imaging applications.

### BRIEF DESCRIPTION

In accordance with aspects of the present technique, a detector module for a radiographic imaging system is presented. The detector module includes an array of direct conversion sensors, the direct conversion sensors having a first side and a second side. The first side of the direct conversion sensors includes a segmented electrode side forming an array of pixels that receive radiation and convert the received radiation into corresponding charge signals, whereas the second side includes a common electrode side. The detector module also includes a readout electronic circuitry coupled to one or more of the direct conversion sensors on the first side where the readout electronic circuitry is shielded from the radiation. In addition, the detector module includes a bias voltage circuitry coupled to the one or more direct conversion sensors on the second side.

In accordance with aspects of the present technique, method for fabricating a detector module for a radiographic imaging system is disclosed. The method includes providing an array of direct conversion sensors having a first side comprising a segmented electrode side and a second side comprising a common electrode side. Further, the array of direct conversion sensors is positioned to receive radiation on the first side and convert the received radiation into corresponding charge signals. Further, a readout electronic circuitry is coupled to one or more of the direct conversion sensors via a flexible interconnect. Additionally, the second side of the one or more direct conversion sensors is coupled to a multilayer substrate via the flexible interconnect or a direct electrical connection, while a spacer element is coupled to the multilayer substrate.

In accordance with aspects of the present system, a CT system is described. The CT system includes a rotatable gantry having an opening to receive an object to be scanned and at least one radiation source operatively coupled to the rotatable gantry and configured to emit radiation towards the object. Further, the CT system includes a detector module that detects the radiation received from the object. Particularly, the detector module includes an array of direct conversion sensors, the direct conversion sensors having a first side and a second side. The first side of the direct conversion sensors includes a segmented electrode side that detects the received radiation and converts the received radiation into corresponding charge signals, whereas the second side includes a common electrode side. The detector module also includes a readout electronic circuitry coupled to one or more of the direct conversion sensors where the readout electronic circuitry is shielded from the radiation. In addition, the detector module includes a bias voltage circuitry coupled to the one or more direct conversion sensors on the second side. Further, the CT system may also include a computing device that acquires projection data corresponding to at least a portion of the object from the detector module and uses the acquired projection data to reconstruct an image of at least the portion of the object.

### DRAWINGS

These and other features, aspects, and advantages of the present technique will become better understood when the following detailed description is read with reference to the accompanying drawings in which like characters represent like parts throughout the drawings, wherein:

FIG. 1 is a pictorial view of a CT imaging system;

FIG. 2 is a block schematic diagram of the CT imaging system illustrated in FIG. 1;

FIG. 3 is a schematic diagram illustrating an exemplary configuration of a detector module, in accordance with aspects of the present technique;

FIG. 4 is a schematic diagram illustrating an exemplary configuration of another detector module, in accordance with aspects of the present technique;

FIG. 5 is a schematic diagram of an exemplary configuration of a flexible interconnect used for coupling one or more components of a detector, in accordance with aspects of the present technique;

FIG. 6 is a diagrammatic illustration of a method for forming a detector module, in accordance with aspects of the present technique;

FIGS. 7(a) and 7(b) are diagrammatic illustrations of exemplary alignments of a plurality of detector modules in a detector array, in accordance with aspects of the present technique; and

FIGS. 8(a) and 8(b) are diagrammatic illustrations of a comparison of count rates as a function of time for a conventional detector and an exemplary detector module, in accordance with aspects of the present technique.

### DETAILED DESCRIPTION

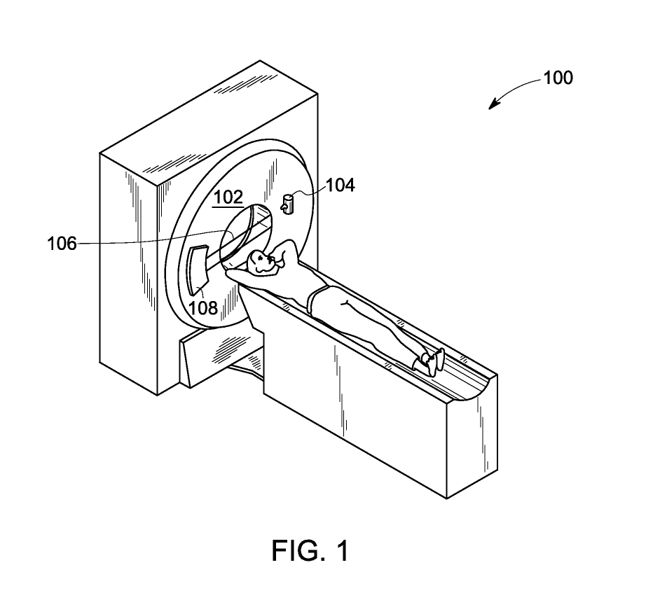

The following description presents detector systems in radiographic imaging systems that support high electric fields and enhanced charge collection efficiency under different imaging conditions. Particularly, embodiments illustrated in the following description disclose an imaging system, such as a computed tomography (CT) system that includes a detector module including an anode incidence face, and a method for fabricating the detector module. Although exemplary embodiments of the present technique are described in the context of a detector module for a CT system, it will be appreciated that use of the present detector module in various other imaging applications and systems such as X-ray projection imaging systems, X-ray diffraction systems, microscopes, digital cameras and charge-coupled devices is also contemplated. An exemplary environment that is suitable for practicing various implementations of the present system is described in the following sections with reference to FIG. 1.

FIG. 1 illustrates an exemplary CT system 100 for acquiring and processing projection data. In one embodiment, the CT system 100 includes a gantry 102. The gantry 102 further includes at least one X-ray radiation source 104 that projects a beam of X-ray radiation 106 towards a detector array 108 positioned on the opposite side of the gantry 102. Although FIG. 1 depicts a single X-ray radiation source 104, in certain embodiments, multiple radiation sources may be employed to project a plurality of X-ray beams for acquiring projection data from different view angles. In one embodiment, the X-ray radiation source 104 projects the X-ray radiation 106 towards the detector array 108 so as to enable acquisition of projection data corresponding to a desired image volume corresponding to a patient.

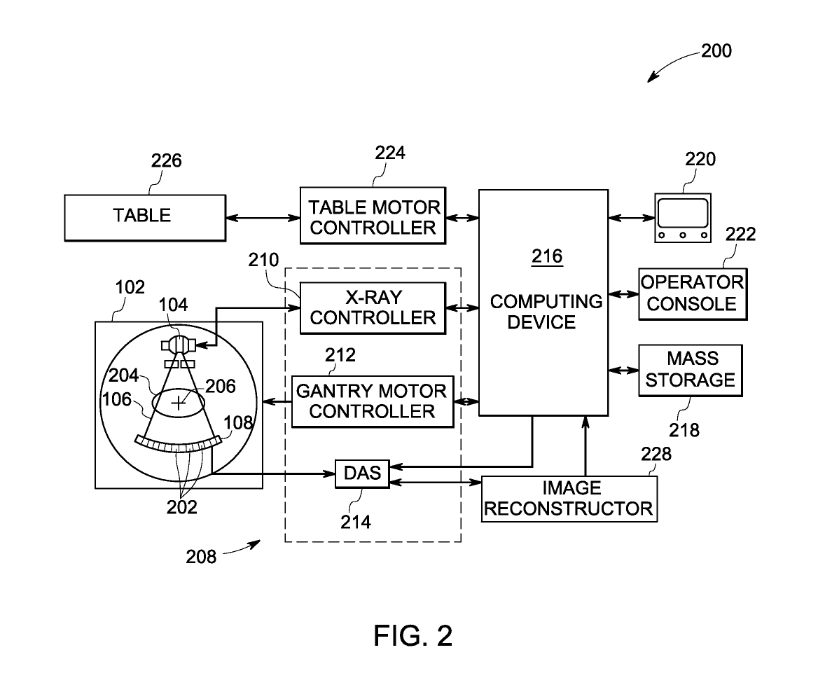

In one embodiment, the detector array 108 includes a plurality of detector modules that includes an array of direct conversion sensors having a first side and a second side. Particularly, the first side of the sensors includes a segmented electrode side or the anode side positioned to receive the X-ray radiation 106, and convert the received X-ray radiation 106 into corresponding charge signals. By way of example, the first side/anode side may be segmented into a two-dimensional array of elements that receive and convert the incident X-ray radiation 106 into corresponding charge signals. The anode incidence configuration of the detector modules enhances the charge collection efficiency of the detector array 108. Exemplary configurations of such detector modules that greatly improve the detector performance will be described in greater detail with reference to FIGS. 2-8.

FIG. 2 illustrates an imaging system 200, similar to the CT system 100 of FIG. 1, including the detector array 108 for acquiring and processing projection data. To that end, the detector array 108 includes a plurality of detector elements 202 that together sense the projected X-ray beams that pass through an object 204, such as a medical patient or baggage, to acquire corresponding projection data. Particularly, in one embodiment, the detector elements 202 may include an array of direct conversion sensors having a first side and a second side, where the first side receives the incident X-ray radiation 106. Accordingly, the detector array 108 may be fabricated in a multi-slice configuration including a plurality of rows of cells or detector elements 202. In such a configuration, one or more additional rows of the detector elements 202 may typically be arranged in a parallel configuration for acquiring projection data.

Further, during a scan to acquire the projection data, the gantry 102 and the components mounted thereon rotate about a center of rotation 206. Alternatively, in embodiments where a projection angle relative to the object 204 varies as a function of time, the mounted components may move along a general curve rather than along a segment of a circle. Accordingly, the rotation of the gantry 102 and the operation of the X-ray radiation source 104 may be controlled by a control mechanism 208 of the imaging system 200 to acquire projection data from a desired view angle and at a desired energy level. In one embodiment, the control mechanism 208 may include an X-ray controller 210 that provides power and timing signals to the X-ray radiation source 104 and a gantry motor controller 212 that controls the rotational speed and position of the gantry 102 based on scanning requirements.

The control mechanism 208 may further include a data acquisition system (DAS) 214 for sampling analog data received from the detector elements 202 and converting the analog data to digital signals for subsequent processing. The data sampled and digitized by the DAS 214 may be transmitted to a computing device 216. The computing device 216 may store this data in a storage device 218, such as a hard disk drive, a floppy disk drive, a compact disk-read/write (CD-R/W) drive, a Digital Versatile Disc (DVD) drive, a flash drive, or a solid state storage device.

Additionally, the computing device 216 may provide appropriate commands and parameters to one or more of the DAS 214, the X-ray controller 210 and the gantry motor controller 212 for operating the imaging system 200. Accordingly, in one embodiment, the computing device 216 is operatively coupled to a display 220 that allows an operator to observe object images and/or specify commands and scanning parameters via an operator console 222 that may include a keyboard (not shown). The computing device 216 uses the operator supplied and/or system defined commands and parameters to operate a table motor controller 224 that, in turn, controls a motorized table 226. Particularly, the table motor controller 224 moves the table 226 for appropriately positioning the object 204, such as the patient, in the gantry 102 to enable the detector elements 202 to acquire corresponding projection data.

As previously noted, conventional detector configurations involve transporting the majority charge carrier corresponding to the acquired projection data over a long travel distance. Particularly, the transport of the charge carriers occurs from the cathode to read-out electronic circuitry, such as the DAS 214, and across the sensor material having charge trapping defects, thus resulting in loss of charge collection efficiency. In accordance with aspects of the present technique, the shortcomings of these conventional detector configurations may be circumvented by fabricating the detector elements 202 such that the segmented anode side of the array of detector elements 202 is configured to receive the incident X-ray radiation 106. As the X-rays radiation 106 are absorbed in the direct conversion sensor material closer to the anode incident surface, the collected charge has a lesser distance to travel towards the DAS 214 resulting in a more stable detector operation.

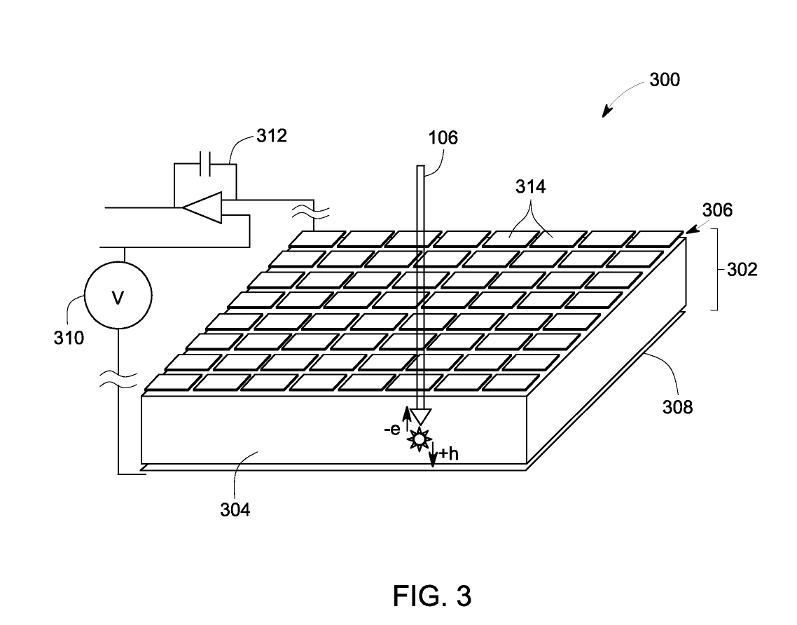

The DAS 214 samples and digitizes the X-ray data corresponding to the collected charge. Subsequently, an image reconstructor 228 uses the sampled and digitized X-ray data to perform high-speed reconstruction of quality images for use in imaging operations, such as those requiring high statistical significance. The image reconstructor 228 then either stores the reconstructed images in the storage device 218 or transmits the reconstructed images to the computing device 216 for generating useful information for diagnosis and evaluation. The computing device 216 may transmit the reconstructed images and other useful information to the display 220 that allows the operator to evaluate the high quality reconstructed images of the desired anatomy. An exemplary configuration of a detector module that enables efficient charge collection to facilitate reconstruction of good quality images is described in greater detail with reference to FIG. 3.

FIG. 3 depicts a diagrammatic illustration of an exemplary configuration of an imaging detector system 300 that typically includes an array of detector elements, similar to the detector elements 202 of FIG. 2, in accordance with aspects of the present technique. In one embodiment, the detector element is a direct conversion sensor 302 comprising a sensor material 304 disposed between a first side 306 and a second side 308 of the direct conversion sensor 302. Further, the first side 306 includes a segmented electrode side subdivided to form an array of pixel elements that receive and convert the X-ray radiation 106 into corresponding charge signals, whereas the second side 308 includes a common electrode side. Specifically, the X-ray radiation 106 incident on the first side 306 is absorbed by the material of the direct conversion sensor 302, thus creating electron hole pairs. To that end, the direct conversion sensor 302 includes materials such as cadmium telluride, cadmium zinc telluride crystals, and polycrystalline compacts and/or film layers of these same compounds. In certain embodiments, other semiconductors such as mercury cadmium telluride, mercuric iodide, thallium bromide, lead iodine, lead oxide, silicon, gallium arsenide may also be used.

Further, the direct conversion sensor 302 includes an electrical connection to a bias voltage circuitry 310, which in turn, may be coupled to the second side 308. The bias voltage circuitry 310 applies an appropriate voltage bias to at least one of the first side 306 and the second side 308 to facilitate movement of charges towards specific contacts on the direct conversion sensor 302. In a presently contemplated configuration, the first side 306 has a positive voltage bias relative to the second side 308. Accordingly, the first side 306 may include an anode that collects electrons and the second side 308 may include a cathode. Unlike conventional detector configurations that are configured to receive X-ray radiation on the second/cathode side 308, the direct conversion sensor 302 receives the incident X-ray radiation on the first/anode side 306. As previously noted, the incident radiation creates electron hole pairs. In one embodiment, the bias voltage circuitry 310 applies a negative bias voltage to the second/cathode side 308, thus causing the cathode to collect the holes and the anode to collect the electrons. In an exemplary implementation, the bias voltage applied to the cathode may be in a range from about −100 volts to about −5000 volts, while the anode is maintained at ground potential.

Accordingly, the positively biased pixel array on the first/anode side 306 is coupled to a readout electronic circuitry 312 to collect the electrons. To that end, the readout electronic circuitry 312 may include one or more acquisition systems such as the DAS 214 of FIG. 2, an application specific integrated circuit (ASIC), field programmable gate arrays (FPGA) and/or other suitable processing systems for collecting relevant data. Particularly, the readout electronic circuitry 312 is coupled to the first/segmented anode side 306 to obtain spatial mapping of the incident X-ray location. To that end, the first/segmented anode side 306 may include a plurality of anode pads 314, each connected to a corresponding channel in the readout electronic circuitry 312.

Typically, the X-rays are absorbed close to the incident location in accordance with the Beer-Lambert Law. Accordingly, in the present configuration, the collected charges for the majority carrier sent to the readout electronic circuitry 312 travel a substantially shorter distance as compared to travelling all across the thickness of the sensor material 304 as in the conventional detector systems. In an exemplary implementation, the thickness of the sensor material 304 may be about 0.1 mm to about 20 mm. The anode illumination configuration of the direct conversion sensor 302, thus, allows use of the thicker sensor material 304 to detect radiation with higher energy photons that otherwise transmit through thin materials, while maintaining short majority carrier transport distance to the segmented anode pads 314. Furthermore, any trapped holes may cause an increase in electric field at corresponding electron locations deep in the sensor material 304. The increase in the electric field further increases the tendency of the electrons to move quickly to the segmented anode pads 314, thus greatly improving the electron collection efficiency of the direct conversion sensor 302. In addition, such expedited electron transport further reduces the chances of electron trapping resulting in more sable detector operation. In one exemplary implementation, a direct conversion sensor with an anode incidence face showed an improvement of about 300% in the charge collection efficiency as compared to a conventional detector configuration having a cathode incidence face.

Configuring the direct conversion sensor 302 to receive X-ray radiation on the anode side, thus, allows use of much higher flux rates and higher intensity X-rays that may be useful in various imaging applications. By way of example, the anode incidence configuration of the direct conversion sensor 302 may enable use of flux rates can ranging from about 10 million counts per sec per millimeter squared to about 1000 Million counts per sec per millimeter squared. The high flux rates and high intensity X-rays, however, may cause radiation damage to the readout electronic circuitry 312. Accordingly, in one embodiment, the readout electronic circuitry 312 is positioned behind the proximate direct conversion sensor 302 in the sensor array so as to be shielded from the X-rays.

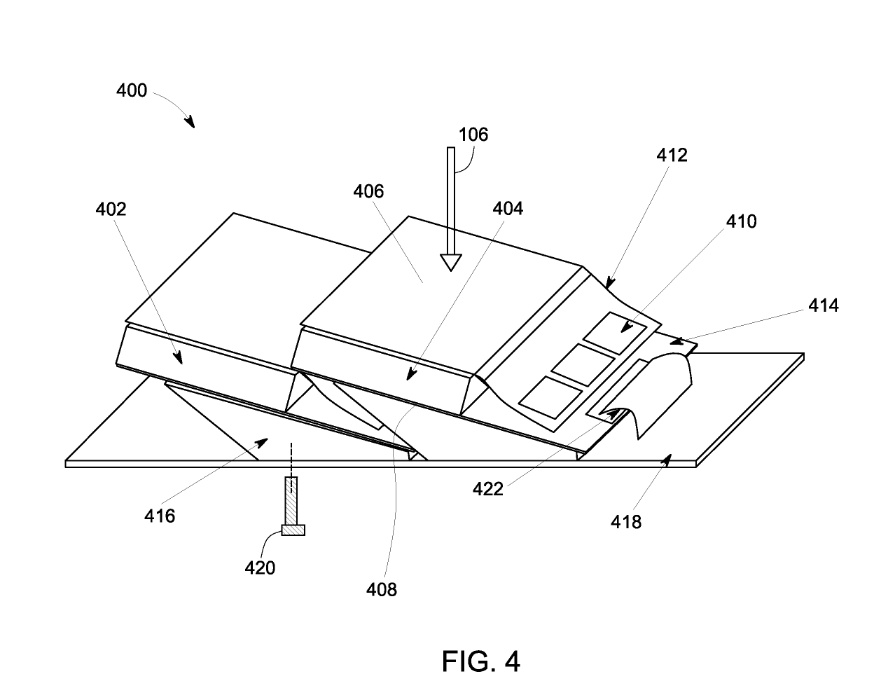

Further, in certain embodiments, the readout electronic circuitry 312 is made radiation hard and is directly coupled to the anode pads 314. Such a radiation hard configuration, for example, can be manufactured as ASIC chips at IC foundries specializing in space applications, while allowing usage of a small gate size and thickness to reduce probability of X-ray interaction. Unfortunately, these configurations may yield lower performance in certain scenarios. Accordingly, in one embodiment, the readout electronic circuitry 312 is oriented behind a proximate direct conversion sensor in a shingled sensor array such that the readout electronic circuitry 312 is shielded from the incident X-ray radiation 106. An exemplary configuration of a direct conversion sensor having an appropriately positioned readout electronic circuitry shielded from the incident radiation is described in greater detail with reference to FIG. 4.

Referring now to FIG. 4, an exemplary configuration of a detector module 400 having a plurality of appropriately positioned direct conversion sensors to prevent radiation damage to corresponding readout electronic circuitry is depicted. Particularly, the configuration illustrated in FIG. 4 depicts the detector module 400 as including a shingled array of direct conversion sensors 402 and 404, each sensor having a first side and a second side. By way of example, the direct conversion sensor 404 has a first side 406 and a second side 408. In one embodiment, the first side 406 includes a segmented electrode side forming an array of pixels configured to receive and convert the X-ray radiation 106 into corresponding charge signals, whereas the second side 408 includes a common electrode side. Further, the first side 406 may be maintained at a positive voltage bias relative to the second side. Accordingly, the first side 406 may include an anode that collects electrons and the second side 408 may include a cathode.

Although, FIG. 4 depicts only two direct conversion sensors 402 and 404, the detector module 400 may include a larger number of sensors configured to receive incident X-ray radiation 106 on the corresponding first side or the segmented anode side. Particularly, in one embodiment, the tiling of the sensors can be analogized by shingles where each shingle covers a portion of the previous shingle. The direct conversion sensors 402 and 404, thus, may be appropriately positioned to shield the readout electronic circuitry of at least one other direct conversion sensors in the sensor array. To that end, a readout electronic circuitry may be connected to one or more sensors in the sensor array. By way of example, FIG. 4 illustrates a readout electronic circuitry 410 connected to the direct conversion sensor 404. Particularly, the anode pads corresponding to the direct conversion sensor 404 may be connected to the readout electronic circuitry 410 using, for example, a flexible interconnect 412 or a direct electrical connection.

Further, in one embodiment, the readout electronic circuitry 410 is positioned behind the adjacent or proximate direct conversion sensor 404 in the sensor array so as to be shielded from the incident X-ray radiation 106. In addition, the readout electronic circuitry 410 may be positioned in the same plane and to one side of the corresponding direct conversion sensor 404 in the sensor array. Particularly, the readout electronic circuitry 410 is positioned to be outside the field of X-ray illumination received from an X-ray source such as the radiation source 104 of FIG. 1.

In certain embodiments, additional protection from the incident X-ray radiation 106 may be achieved by positioning or shingling the direct conversion sensors 402 and 404 in the sensor array at an angle such that the readout electronic circuitry of the direct conversion sensor 402 is shielded by the subsequent or proximate direct conversion sensor 404. In one example, the read out electronics 410 for the direct conversion sensor 402 is disposed between the adjacent direct conversion sensor 404 and the spacer element 416 or the detector board 418. Similarly, a subsequent direct conversion sensor (not shown) may be disposed at an angle to shield the readout electronic circuitry 410 of the direct conversion sensor 404, and so on. For clarity, the description of certain elements of the detector module 400 will be disclosed in the following sections with reference to the direct conversion sensor 404. The disclosed elements, however, may also be applicable to the configuration of the other direct conversion sensors disposed in the sensor array.

Further, in one embodiment, a first side or a segmented anode side 406 of the direct conversion sensor 404 is coupled to the corresponding readout electronic circuitry 410 via the flexible interconnect 412. By way of example, the direct conversion sensor 404 may be soldered to the flexible interconnect 412 or attached by a laser bonding method. Further, the second side 408 of the direct conversion sensor 404 may be in contact with and/or is electronically coupled to a multilayer substrate 414. As used herein, the term “flexible” refers to the ability of the flexible interconnect 412 to be disposed around one or more surfaces of the direct conversion sensor 404 and/or the multilayer substrate 414 such that the flexible interconnect 412 conforms to the contour of the surfaces on which it is disposed. To that end, the flexible interconnect 412 includes materials such as Kapton®, polyimide, polyethylene, polypropylene, Ultem® polyetherimide, flexible printed circuit, or combinations thereof.

In certain embodiments, the flexible interconnect 412 may further include a plurality of electrical contact elements or points (not shown) disposed on certain surfaces of the flexible interconnect 412. Particularly, the plurality of electrical contact elements may be configured to couple corresponding electrical contact points on the direct conversion sensor 404 to corresponding contact points on the multilayer substrate 414, thus providing an electrical path between the coupled elements. By way of example, the flexible interconnect 412 may individually couple the anode pads (not shown in FIG. 4) on the first side 406 of the direct conversion sensor 404 to the read out channels in the corresponding readout electronic circuitry 410. Accordingly, the flexible interconnect 412 may further include electrical conductive elements such as metal solder traces, nanowires, conducting polymer ribbon, or combinations thereof, at least on corresponding top and bottom surfaces of the flexible interconnect 412. Particularly, the flexible interconnect 412 may include the electrical conductive elements for providing the electrical paths between the direct conversion sensor 404 and the multilayer substrate 414. The flexible interconnect 412, thus allows flexibility in the choice of the material of the multilayer substrate 414 to provide both desired mechanical properties and/or electrical properties such as stress, strain and/or tolerance without being constrained by issues of mechanical strength dictated by conventional drilling approaches.

Accordingly, the multilayer substrate 414 includes materials such as glass, ceramic, plastic, metal, paper, polymer, composite, or combinations thereof. Particularly, in one embodiment, the multilayer substrate 414 is a multilayer ceramic that isolates high voltages (about 600 V on the cathode) from the other components of the detector module 400. To that end, the ceramic multilayer substrate 414 may be a non-electrical or mechanical ceramic circuit board coupled to the cathode/second side 408 of the direct conversion sensor 404 through an electrically conductive trace or a wired connection. Alternatively, the ceramic multilayer substrate 414 may inherently include electrical connections.

According to aspects of the present technique, the ceramic multilayer substrate 414 is further coupled to at least one spacer element 416. Particularly, the spacer element 416 interfaces two or more detector modules to a detector board 418. To that end, the spacer element 416 may be coupled to the detector board 418 using a fastening mechanism 420 such as alignment pins, screws, interlocking clamp, key/slot configuration, adhesive and/or other suitable device. In one embodiment, the spacer element 416 is a wedge shaped spacer positioned to align the direct conversion sensors 402 and 404 in the sensor array at a desired angle. Specifically, the spacer element 416 is configured to align the direct conversion sensors 402 and 404 such that the readout electronic circuitry (not shown) of the direct conversion sensor 402 is shielded by the subsequent direct conversion sensor 404 in the sensor array.

The spacer element 416, thus serves as a mechanical support for the detector board 418. In addition, the spacer element 416 may also be adapted to accommodate fan angle(s) in wide cone beam designs that involve a curved geometry for the detector surface. By way of example, a wedge shaped spacer element can accommodate the curve of a curved detector, such as the detector 108 of FIG. 2. In certain embodiments, however, the spacer element 416 may additionally serve as a temperature stabilizer for cooling the direct conversion sensor 404 and/or the multilayer substrate 414 that may heat up due to the incident X-ray radiation 106. To that end, the spacer element 416 may include polymetric materials, metals, ceramic materials, or combinations thereof.

In one embodiment, the flexible interconnect 412 is coupled to anode pads disposed on the first side 406 of the direct conversion sensor 404, whereas the cathode disposed on the second side 408 is coupled to the multilayer substrate 414. The multilayer substrate 414, in turn, is coupled to the spacer element 416. Particularly, the direct conversion sensor 404, the flexible interconnect 412, the multilayer substrate 414 and the spacer element 416 together may form a field replaceable unit of the detector module 400 for use in the imaging system. A plurality of such field replaceable units may be grouped together, for example, via interlocking slots in a detector system to cover a large area. Similarly, these field replaceable units may easily be taken apart to modify the detector configuration. To that end, a connector and/or a flexible cable 422 may be employed for coupling and/or decoupling the field replaceable units on one or more detector boards, thus facilitating the replaceability of the detector module 400 on the detector board 418. The flexible cable 422 may additionally enable transmission of power and digital communication signals between detector modules disposed on different detector boards.

The presently contemplated configuration of the detector module 400 receives incident X-ray radiation 106 on the first side 406. Conventional packaging approaches, however, may require transport of the incident X-ray radiation 106 across the packaging area leading to significant photon loss, which in turn, may reduce the dose efficiency of the detector module 400. To that end, one or more specific packaging configurations may be employed to maintain the charge collection efficiency of the detector module 400.

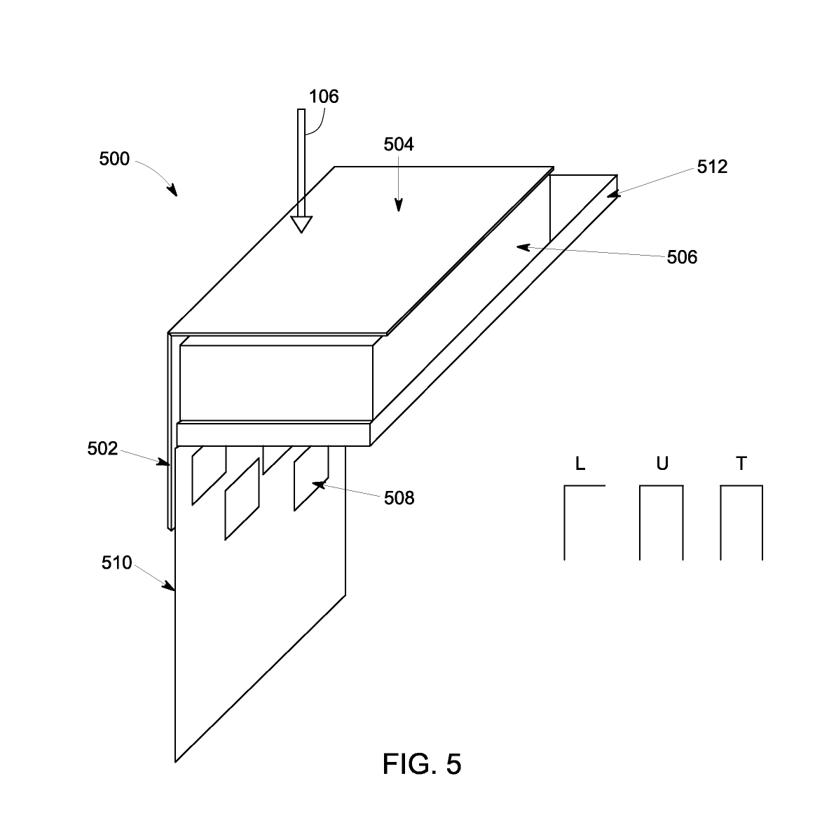

By way of example, FIG. 5 illustrates an exemplary configuration of a flexible interconnect, such as the flexible interconnect 412 of FIG. 4, used for coupling one or more components of the detector module 400. Although FIG. 5 illustrates only a few detector components for clarity, the detector module 500 may include other components such as those illustrated in FIG. 4. Accordingly, in one embodiment, a flexible interconnect 502 is configured to couple a first side 504 of a direct conversion sensor 506 to a corresponding readout electronic circuitry 508.

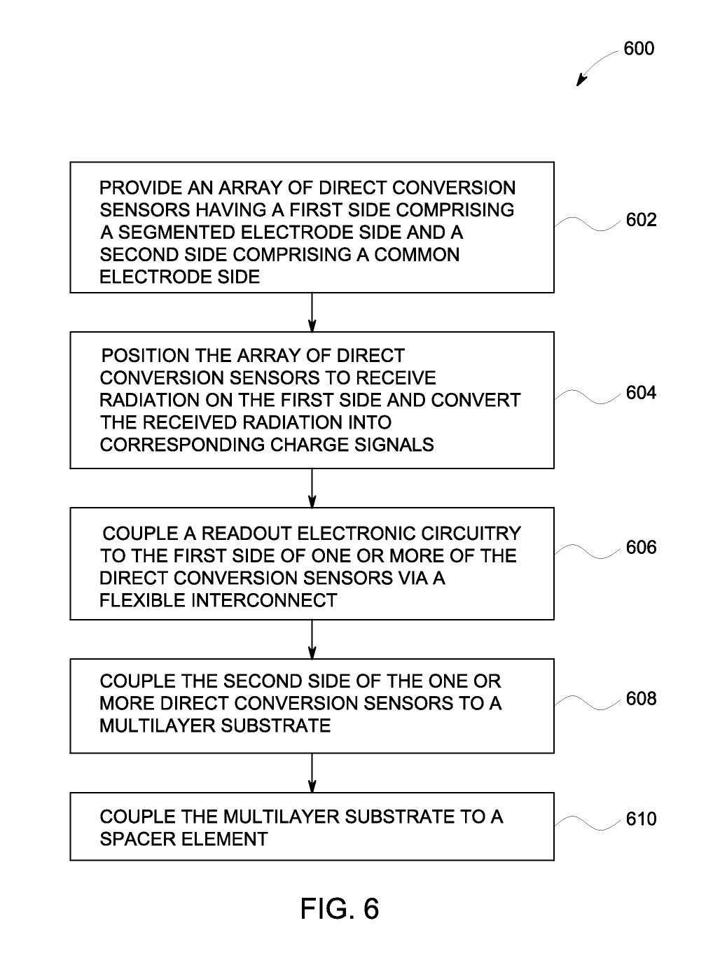

Unlike the embodiment illustrated in FIG. 4, where the direct conversion sensor 404 and the readout electronic circuitry 410 are in the same plane, the flexible interconnect 502 of FIG. 5 is configured to position the readout electronic circuitry 508 in a plane substantially perpendicular to the corresponding direct conversion sensor 506. Particularly, a portion of the flexible interconnect 502 is disposed along the first side 504 of the direct conversion sensor 506, while another portion of the flexible interconnect 502 bends at about 90 degrees and is disposed along a detector board 510 corresponding to the direct conversion sensor 506. The configuration of the flexible interconnect depicted in FIG. 6 may generally be referred to as an “L” configuration.

Further, the detector module 500 may employ a spacer element 512, for example, a flat wedge spacer that supports the direct conversion sensor 506 disposed in a horizontal plane. The embodiment illustrated in FIG. 5 advantageously couples anode pads on the first side 504 along a horizontal plane to analog input channels of the readout electronic circuitry 508 disposed in a vertical plane to significantly improve the charge collection efficiency of the detector module 500. Specifically, the “L” configuration ensures that the X-ray radiation 106 incident on the first side 504 has a much lesser distance to travel towards the readout electronic circuitry 508, while also shielding the readout electronic circuitry 508 from the incident X-ray radiation 106.

Although the embodiment illustrated in FIG. 5 depicts the “L” configuration of the flexible interconnect 502, the flexible nature of the flexible interconnect 502 lends itself to several alternative embodiments. By way of example, in a “U” configuration, the flexible interconnect 502 wraps around two sides of the detector module 500. Similarly, in a “T” configuration, a first portion of the flexible interconnect 502 wraps around the first side 504, while two other portions of the flexible interconnect 502 coincide in the center of the direct conversion sensor 506. Particularly, use of smaller portions of the flexible interconnect 502 further improves the charge collection efficiency and the manufacturability of the flexible interconnect 502 with high density interconnects.

Turning to FIG. 6, a flow chart 600 depicting an exemplary method for fabricating a detector module, in accordance with certain aspects of the present technique is presented. Further, in FIG. 6, the exemplary method is illustrated as a collection of blocks in a logical flow chart, which represents operations that may be implemented in hardware, software, or combinations thereof. The various operations are depicted in the blocks to illustrate the functions that are performed generally during different phases of the exemplary method.

In the context of software, the blocks represent computer instructions that, when executed by one or more processing subsystems, perform the recited operations. The order in which the exemplary method is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein. For discussion purposes, the exemplary method will be described with reference to the elements of FIGS. 3-5.

At step 602, an array of direct conversion sensors, such as the direct conversion sensors 402 and 404 of FIG. 4, having a first side comprising a segmented electrode side and a second side comprising a common electrode side is provided. Next at step 604, the array of direct conversion sensors is positioned to receive X-rays on the first side and convert the received X-rays into corresponding charge signals. To that end, the first side of the direct conversion sensors corresponds to a segmented electrode side and the second side of the direct conversion sensors corresponds to a common electrode side. Additionally, the first side has a positive voltage bias relative to the second side. Accordingly, in one embodiment, the first side includes an anode side, while the second side includes a cathode side.

Further, at step 606, a readout electronic circuitry, such as the readout electronic circuitry 410 of FIG. 4, is coupled to the first side via a flexible interconnect such as the flexible interconnect 412. Additionally, at step 608, the second side is coupled to a multi-layer substrate such as the multilayer substrate 414 of FIG. 4 via, for example, the flexible interconnect or a direct electric connection. Particularly, in one embodiment, the direct conversion sensors in the sensor array are arranged on the multilayered substrate at an angle such that the readout electronic circuitry of a direct conversion sensor in the sensor array is shielded by a subsequent direct conversion sensor. In another embodiment, the readout electronic circuitry is positioned behind a corresponding direct conversion sensor in the sensor array so as to be shielded from the X-rays. Alternatively, the readout electronic circuitry may be positioned in the same plane and to one side of the corresponding direct conversion sensor. In certain other embodiments, the readout electronic circuitry is positioned in the “L,” “U” or “T” configuration with the corresponding direct conversion sensor in the sensor array.

In one or more of these configurations, the flexible interconnect couples electrical contact points on the direct conversion sensor to corresponding points on the multilayer substrate, thus providing an electrical path between the coupled elements. Particularly, the flexible interconnect may individually couple the anode pads on the first side of the direct conversion sensor to readout channels in the corresponding readout electronic circuitry. Such coupling reduces the travel distance of the collected charges towards the readout electronic circuitry, thus improving the charge collection efficiency, while also shielding the readout electronic circuitry from the incident radiation.

Moreover, at step 610, the multilayer substrate is coupled to a spacer element such as the spacer element 416 of FIG. 4. Particularly, the spacer element interfaces two or more detector modules to a detector board. The spacer element, thus serves as a mechanical support for appropriately positioning the direct conversion sensors to not only reduce the travel distance for the collected charge by receiving incident X-ray radiation on the anode side, but may also shield the readout electronics from the incident radiation. In certain embodiments, however, the spacer element may additionally serve as a temperature stabilizer for cooling the direct conversion sensor and/or the multilayer substrate that may heat up due to the incident X-ray radiation.

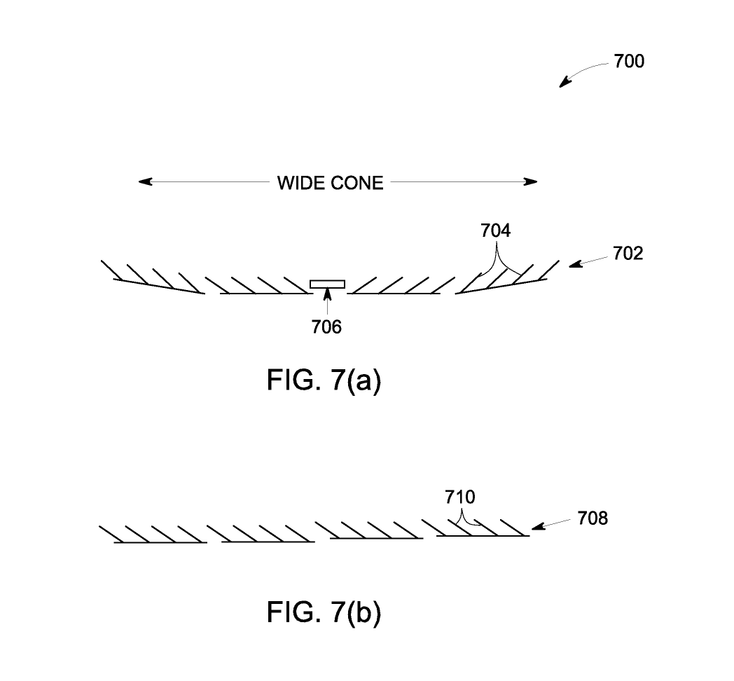

The detector modules, thus fabricated, are then arranged in a determined pattern to cover a large area. Particularly, FIGS. 7(a) and 7(b) depict exemplary alignments 700 of a plurality of detector modules in a detector array. By way of example, in a fan-beam or a cone-beam CT imaging system, the detector modules may be arranged in a flat array, a stepped array or a curved array to cover a large area. Generally, the curvature of a surface of the detector array is used to point the detector elements in line with the X-ray beam as the X-ray beam is emitted radially from a radiation source, such as the radiation source 104 in FIG. 2. An arrangement 702 of detector modules 704 depicted in FIG. 7(a), for example, illustrates an array of detector modules shingling away from the center 706. However, the arrangement 708 depicted in FIG. 7(b) illustrates an array of detector modules 710 shingling in same direction.

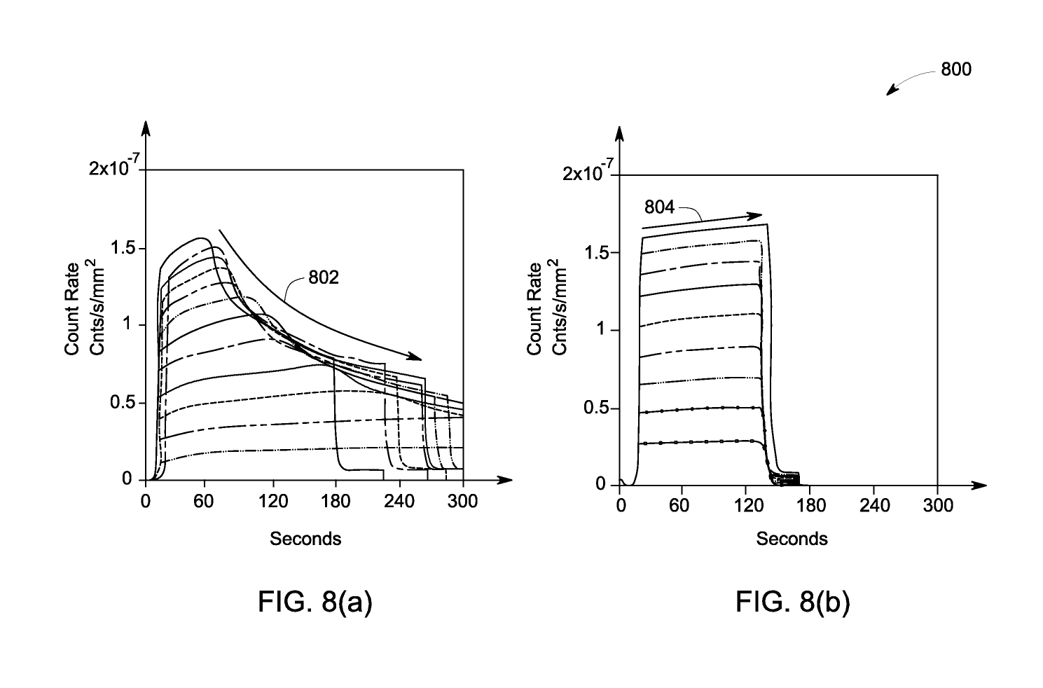

The presently contemplated configuration of the detector modules as described with reference to FIGS. 3-7 provides much higher charge collection efficiency than conventional detector modules. A comparison of the count rate versus time for a conventional and the presently contemplated detector configurations may be presented with reference to FIGS. 8(a) and 8(b). Specifically, FIGS. 8(a) and 8(b) depict diagrammatic representations 800 of a comparison of the count rate versus time for a conventional detector configuration and the exemplary anode-illumination configuration presented in FIG. 3.

In particular, FIG. 8(a) depicts plots of count rate vs. time for the conventional detector configuration, while FIG. 8(b) is representative of plots of the count rate vs. time for the exemplary anode-illumination configuration. As shown in FIG. 8(a), the conventional detector configuration shows decreasing count instability in time due to charge trapping with the cathode illumination. This decreasing count instability is generally represented by reference numeral 802. However, as depicted by the curve 804 illustrated in FIG. 8(b), the count rate corresponding to the anode-illumination configuration is substantially stable over time. Configuring the direct conversion sensor to receive X-ray radiation on the anode side, thus, allows use of much higher flux rates and higher intensity X-rays that are required in various imaging applications.

The detector systems and methods of fabricating the same disclosed hereinabove describe a detector module that includes a segmented electrode side positioned to receive incident X-ray radiation, the segmented electrode side having a positive voltage bias relative to a second common electrode side. Receiving the incident X-ray radiation on the segmented electrode/anode side reduces the travel distance of the collected charge towards the readout electronics, thus minimizing losses due to charge trapping in the sensor. Further, various interconnect and spacer configurations have been presented that effectively shield the readout electronics from the incident radiation, while retaining the enhanced charge collection efficiency achieved by the use of the anode incidence face.

Although exemplary embodiments of the present technique are described in the context of a detector module for a CT system, it will be appreciated that use of the present detector module in various other imaging applications and systems is also contemplated. Some of these systems may include an X-ray projection radiography, fluoroscopy and tomography, a positron emission tomography (PET) scanner, a multiple source imaging system, a multiple detector imaging system, a single photon emission computed tomography (SPECT) scanner, microscopes, digital cameras, charge coupled devices, or combinations thereof.

While only certain features of the present invention have been illustrated and described herein, many modifications and changes will occur to those skilled in the art. It is, therefore, to be understood that the appended claims are intended to cover all such modifications and changes as fall within the true spirit of the invention.

1. A detector module for a radiographic imaging system, comprising:
an array of direct conversion sensors, the direct conversion sensors having a first side and a second side, wherein the first side comprises a segmented electrode side forming an array of pixels that receive radiation and convert the received radiation into corresponding charge signals, and wherein the second side comprises a common electrode side;
a readout electronic circuitry coupled to one or more of the direct conversion sensors on the first side and configured to be shielded from the radiation; and
a bias voltage circuitry coupled to one or more of the direct conversion sensors on the second side.

2. The detector module of claim 1, wherein the first side comprises an anode that collects electrons and the second side comprises a cathode.

3. The detector module of claim 2, wherein the first side has a positive voltage bias relative to the second side.

4. The detector module of claim 1, wherein the readout electronic circuitry is positioned behind a direct conversion sensor proximate the one or more direct conversion sensors so as to be shielded from the radiation.

5. The detector module of claim 1, wherein the readout electronic circuitry is positioned in the same plane as the one or more direct conversion sensors and to one side of the one or more direct conversion sensors so as to be shielded from the radiation.

6. The detector module of claim 1, wherein the one or more direct conversion sensors are positioned at an angle such that the readout electronic circuitry coupled to the one or more direct conversion sensors is shielded by proximate direct conversion sensors.

7. The detector module of claim 1, wherein the first side of the one or more direct conversion sensors is coupled to the readout electronic circuitry via a flexible interconnect.

8. The detector module of claim 7, wherein the second side of the one or more direct conversion sensors is coupled to a multilayer substrate via the flexible interconnect or a direct electrical connection, and wherein the multilayer substrate is further coupled to a spacer element.

9. The detector module of claim 8, wherein the spacer element is a temperature stabilizer.

10. The detector module of claim 7, wherein the flexible interconnect is configured to couple the first side of the one or more direct conversion sensors to the readout electronic circuitry positioned substantially perpendicular to the one or more direct conversion sensors.

11. The detector module of claim 7, wherein the flexible interconnect is configured to wrap around the first side and the second side of the one or more direct conversion sensors.

12. The detector module of claim 7, wherein the flexible interconnect is configured such that two portions of the flexible interconnect meet in the center of the one or more direct conversion sensors.

13. The detector module of claim 1, wherein the radiographic imaging system is a photon counting system that provides a short travel distance of a majority carrier to provide a desired count rate.

14. The detector module of claim 1, wherein the direct conversion sensors in the array of direct conversion sensors are aligned in one or more directions.

15. A method for fabricating a detector module for an imaging system, comprising:
providing an array of direction conversion sensors, the direct conversion sensors having a first side comprising a segmented electrode side and a second side comprising a common electrode side;
positioning the array of direct conversion sensors to receive radiation on the first side and convert the received radiation into corresponding charge signals;
coupling a readout electronic circuitry to the first side of one or more of the direct conversion sensors via a flexible interconnect;
coupling the second side of the one or more direct conversion sensors to a multilayer substrate via the flexible interconnect or a direct electrical connection; and
coupling a spacer element to the multilayer substrate.

16. The method of claim 15, further comprising positioning the readout electronic circuitry behind a direct conversion sensor proximate the one or more direct conversion sensors so as to be shielded from the radiation.

17. The method of claim 15, further comprising positioning the readout electronic circuitry in the same plane as the one or more direct conversion sensors and to one side of the one or more direct conversion sensors so as to be shielded from the radiation.

18. The method of claim 15, further comprising positioning the one or more direct conversion sensors at an angle such that the readout electronic circuitry is shielded by proximate direct conversion sensors.

19. The method of claim 15, further comprising positioning the readout electronic circuitry substantially perpendicular to the one or more direct conversion sensors.

20. The method of claim 15, further comprising wrapping the flexible interconnect around the first side and the second side of the one or more direct conversion sensors.

21. The method of claim 15, further comprising configuring the flexible interconnect such that two portions of the flexible interconnect meet in the center of the one or more direct conversion sensors.

22. The method of claim 15, further comprising aligning the direct conversion sensors in one or more directions.

23. A computer tomography (CT) system, comprising:
a rotatable gantry having an opening to receive an object to be scanned;
at least one radiation source operatively coupled to the rotatable gantry and configured to emit radiation towards the object;
a detector module that detects the radiation received from the object, wherein the detector module comprises:
an array of direct conversion sensors, the direct conversion sensors having a first side and a second side, wherein the first side comprises a segmented electrode side that detects the received radiation and converts the received radiation into corresponding charge signals, and wherein the second side comprises a common electrode side;
a readout electronic circuitry coupled to one or more of the direct conversion sensors on the first side, wherein the readout electronic circuitry is configured to be shielded from the radiation;
a bias voltage circuitry coupled to at least the second side; and
a computing device that acquires projection data corresponding to at least a portion of the object from the detector module and uses the acquired projection data to reconstruct an image of at least the portion of the object.
